(19) United States
(12) Patent Application Publication
(10) Pub. No.: US 2025/0112369 A1
(43) Pub. Date: Apr. 3, 2025

(54) SLOT-FED PATCH ANTENNA FOR GNSS APPLICATIONS

(71) Applicant: TOPCON POSITIONING SYSTEMS, INC., Livermore, CA (US)

(72) Inventors: Andrey Vitalievich ASTAKHOV, Moscow (RU); Anton Pavlovich STEPANENKO, Moscow (RU); Pavel Petrovich SHAMATULSKY, Moscow (RU); Sergey Nikolaevich YEMELIANOV, Moscow (RU)

(73) Assignee: TOPCON POSITIONING SYSTEMS, INC., Livermore, CA (US)

(21) Appl. No.: 18/729,190

(22) PCT Filed: Nov. 24, 2022
(86) PCT No.: PCT/RU2022/000347

§ 371 Date: Jul. 16, 2024

(51) Int. Cl. H01Q 9/04; G01S 19/22; H01Q 13/06

(52) U.S. Cl. CPC H01Q 9/0414; G01S 19/22; H01Q 9/0421; H01Q 9/0428; H01Q 13/065

(57) ABSTRACT

A broadband GNSS antenna has a broadband patch radiator with top slot excitation and a one-groove slotted vertical choke-ring structure around the patch radiator. The patch radiator includes a radiator ground plane, a slotted-fed radiation patch, a broadband feeding network, and a set of elements with vertical currents. The vertical choke-ring structure contains a top conducting surface with a set of slots, a bottom conducting surface and an adjacent vertical conducting cylinder.

### FIELD OF THE INVENTION

The present invention relates generally to antennas, and more particularly to broadband circularly polarized antennas with improved multipath rejection for receiving signals from Global Navigation Satellite Systems (GNSS).

### BACKGROUND

One factor affecting the quality of positioning information determined based on data from Global Navigation Satellite System (GNSS) satellites is the performance of the receiving antenna. One source of positioning error is multipath signals. Multipath signals are signals from GNSS satellites received by an antenna via paths other than a direct path from a GNSS satellite to the antenna. Such signals can be caused by the signal from the GNSS satellite reflecting off of an object near the antenna. For example, objects located under the antenna can produce reflected signals. Multipath signals are categorized into far-field multipath signals and near-field multipath signals. Far-field multipath signals are the result of reflections from objects located at a distance of several wavelengths (for example, five wavelengths) and farther. The surface of the ground under an antenna can be considered to be an object located at a distance of several wavelengths. Near-field multipath signals are produced by objects located no farther than a distance of a few wavelengths from the antenna. Such objects are primarily antenna fittings such as, for example, a tribrach. GNSS base station antennas require an efficient level of multipath signal suppression.

Qualitative parameters pertaining to the suppression of far-field multipath signals include a radiation pattern (RP) and, in particular, a level of the back lobe or the front to back ratio. Qualitative parameters pertaining to the suppression of near-field multipath signals can be expressed by a magnitude of the near field and, in particular, by the distribution of a horizontal component of an electric field vector of the near field occurring under the antenna along the antenna's symmetry axis.

Signals broadcast by GNSS satellites typically have right-handed circular polarization (RHCP). The full GNSS frequency band is divided into two smaller frequency bands: low-frequency (LF) (about 1165-1300 MHz) and high-frequency (HF) (about 1525-1605 MHz).

A GNSS antenna should provide stability of a phase center and azimuthal RP symmetry within a required bandwidth. This can be accomplished by using four feeding points. Microstrip patch antennas excited by probes or slots can be used in this application. Slot excitation allows for a compact feeding network to be used.

Positioning information generated using signals from GNSS satellites can be accomplished using antennas receiving RHCP signals coming from directions above the horizon and suppressing multipath signals coming from directions under the horizon. Such an antenna should have a feeding network providing four feed points and the feeding network should operate over the entire GNSS frequency band.

A conventional patch antenna with a flat ground plane does not sufficiently suppress multipath signals for GNSS antenna applications. If the size of the ground plane is equal to that of the radiation patch, then the back lobe signal level is the same as the main lobe signal level. In order to decrease the back lobe level, a patch antenna can be installed on a special ground plane. For example, the patch antenna can be installed on a choke-ring.

FIG. 1 shows a prior art antenna described in U.S. Pat. No. 6,940,457 as being configured to receive GNSS signals. Multi-frequency slot-fed antenna 101 has an edge-diffraction reflector 102 attached to its rear side. Lossy-dielectric-magnetic material 103 encloses opposing sides and the rear side of antenna 101 in order to reduce multipath signals. Edge-diffraction reflector 102 comprises a set of stacked grooves 104, 105, 106, 107 formed by adjacent plates and center cylinders. This type of edge-diffraction reflector design is often referred to as a vertical choke-ring. The multi-frequency antenna is a stacked patch antenna in the form of a set of two patch radiators 108, 109 that are located one above the other. The lower patch radiator has a set of excitation slots that are excited by a microstrip line. The graphs shown in U.S. Pat. No. 6,940,457 illustrate that achieving a front-to-back level on the order of 20 dB or more requires designing an edge-diffraction reflector with at least two stacked grooves. For the LF band, a pair of stacked grooves 104, 105 of a particular depth is used. For the HF band, a pair of stacked grooves 106, 107 having a depth different from the particular depth of stacked grooves 104, 105 is used. In order to provide the required level of front-to-back ratio in both LF and HF bands, at least four stacked grooves 104, 105, 106, 107 with different depths are used. The availability of a set of stacked patch radiators 108, 109, as well as a set of stacked grooves 104, 105, 106, 107 makes this antenna complicated and difficult to manufacture.

The prior art antenna shown and described in U.S. Pat. No. 10,197,679 pertains to an antenna design having good suppression for both far-field and near-field multipath signals. The antenna ground plane is a printed circuit board (“PCB”) having inductance and resistance and includes a slot. To suppress near-field multipath signals, there are additional vertical mushroom-shaped elements. These attributes make this antenna complicated and difficult to manufacture.

What is needed is a patch antenna for GNSS applications having far-field and near-field multipath suppression that has a minimum number of components and is easy to manufacture.

### SUMMARY

An antenna according to one embodiment has a vertical axis and includes a patch radiator, a ground plane, a dielectric, a plurality of vertical conductors, and a choke ring structure. The patch radiator includes a printed circuit board (“PCB”) including a feeding network and a slot-fed radiating patch that is perpendicular to the vertical axis and includes a set of four excitation slots connected to the feeding network through microstrip lines. The dielectric and/or plurality of vertical conductors are located between the ground plane and the slot fed radiating patch and are configured to carry one or both of conduction currents and/or polarization currents flowing in the direction of the vertical axis. The feeding network configured to ensure reception or transmission of a right hand circularly polarized (“RHCP”) wave. The choke ring structure comprises a top conducting surface, a bottom conducting surface, and a conducting cylinder. The top conducting surface includes a set of extended slots, each slot having an end located on the outer perimeter of the top conducting surface. The conducting cylinder includes a top edge and a bottom edge, the top edge connected to the top conducting surface and the bottom edge connected to the bottom conducting surface, the ground plane connected to the conducting cylinder along the outer edge of the ground plane.

In one embodiment, the antenna also includes four capacitive circuits located on the PCB beyond the outer perimeter of the slot-fed radiating patch with each of the circuits having a first end, a second end, and at least three capacitors connected together in series. In one embodiment, the first end of each of the four capacitive circuits is connected to a respective first point located on the perimeter of the slot-fed radiating patch, the second end of each capacitive circuit connected to a respective second point located on the perimeter of the slot-fed radiating patch, the respective first point and the respective second point located on opposite sides of a corresponding one of the set of four excitation slots, a first of the at least three capacitors located near the first point, a second of the at least three capacitors located near the second point, and a third of the at least three capacitors located opposite a corresponding excitation slot.

In one embodiment, the three capacitors are formed using lumped elements. In one embodiment, a third capacitor of the at least three capacitors is formed as a distributed element including three conductors located on a first side of the PCB and a set of compensating conductors located on a second side of the PCB, wherein a first conductor of the three conductors comprises a first end connected to a first capacitive element and a second end that is insulated, a second conductor of the three conductors comprises a first end connected to the second capacitive element and a second end that is insulated, a third conductor located opposite the excitation slot, both ends of the third conductor are insulated, the set of compensating conductors located between the third conductor and the first conductor, and between the third conductor and the second conductor, and the first end of the third conductor having an overlap with the second end of the first conductor, the second end of the third conductor having an overlap with the second end of the second conductor.

In one embodiment, the dielectric comprises a dielectric cylinder having a top surface and a bottom surface, the top surface adjacent to the PCB, the bottom surface adjacent to the ground plane. Each of the plurality of conductors located between the ground plane and the slot-fed radiating patch can include a pin connected to the ground plane and located inside the outer perimeter of the PCB. Each of the excitation slots can be substantially straight and have an end located at an outer perimeter of the slot-fed radiating patch or be T-shaped and have an end located at an outer perimeter of the slot-fed radiating patch. A set of conductive ribs can be connected to the ground plane and located outside the outer perimeter of the PCB. In one embodiment, each slot of the set of extended slots on the top conducting surface is rotated at an angle. In one embodiment, the bottom conducting surface includes a set of extended slots each of which having an end located on the outer perimeter of the bottom conducting surface. In one embodiment, the bottom conducting surface, the conducting cylinder, the ground plane, and the set of conductive ribs are formed as one piece.

In one embodiment, an antenna has a vertical axis and includes a one-groove slotted vertical choke-ring structure that has a top conducting slotted surface, a one-piece component attached to the top conducting slotted surface, and a patch radiator connected to the one-piece component.

### BRIEF DESCRIPTION OF THE DRAWINGS

In the drawings, like numerals describe similar components in different Figures. Like numerals having different letter suffixes represent different instances of similar components and/or signals.

FIG. 1 shows a prior art antenna;

FIG. 2A shows a side view of antenna according to one embodiment;

FIG. 2B shows isometric views of the antenna shown in FIG. 2A;

FIG. 2C shows an isometric view of an antenna according to one embodiment that is a variant of the antenna shown in FIG. 2B;

FIG. 3 shows a patch radiator with the top slot excitation according to an embodiment;

FIG. 4 shows an arrangement of a radiator ground plane and vertical pins according to one embodiment;

FIG. 5 shows a slot-fed radiating patch according to one embodiment;

FIGS. 6A-B show a printed circuit board (“PCB”) with a slot-fed radiation patch according to one embodiment;

FIG. 6C shows a capacitive circuit according to one embodiment;

FIG. 6D shows a PCB section having compensated conductors of capacitive circuits and equivalent capacitors according to one embodiment;

FIG. 7 shows a schematic of a limiting case of dimensions of a patch radiator according to an embodiment;

FIG. 8 shows a graph of normalized radiation patterns;

FIG. 9 shows a signal propagation diagram illustrating operation of an antenna according to one embodiment;

FIG. 10 shows a graph pertaining to experimental plots of front-to-back ratio showing decibels (dB) versus frequency;

FIG. 11 shows a graph pertaining to a horizontal component of an E-field in a back area near-field region;

FIG. 12 shows a graph of experimental plots of radiation patterns for different slot angles;

FIG. 13 shows a graph of voltage standing wave ratio (“VSWR”) dependence on frequency showing VSWR versus frequency in MHz; and

FIG. 14 shows an antenna in accordance with one embodiment.

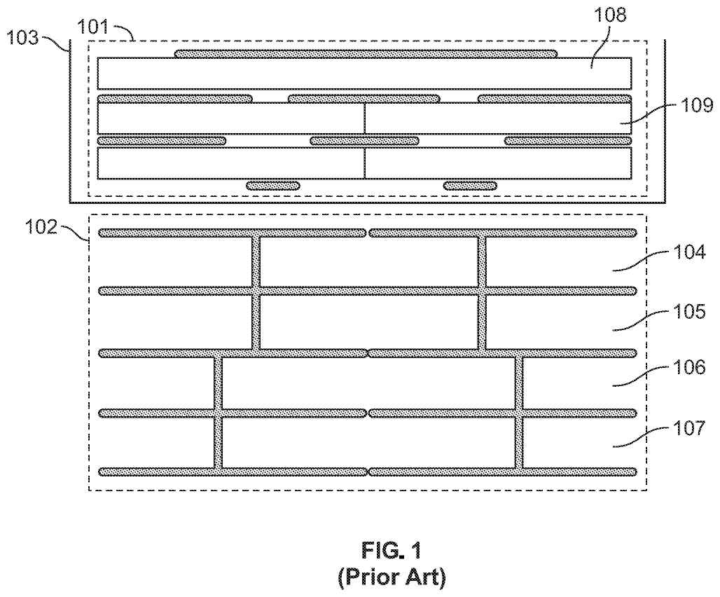

### DETAILED DESCRIPTION

A broadband right-hand circularly polarized (RHCP) antenna for global navigation satellite system (GNSS) applications is described herein having a radiating patch and a one-groove of a vertical choke-ring structure. In one embodiment, the antenna has only one radiating patch and one groove in a vertical choke-ring structure. This antenna design suppresses multipath signals and provides a front to back ratio of more than 20 dB for all frequencies in the GNSS frequency range.

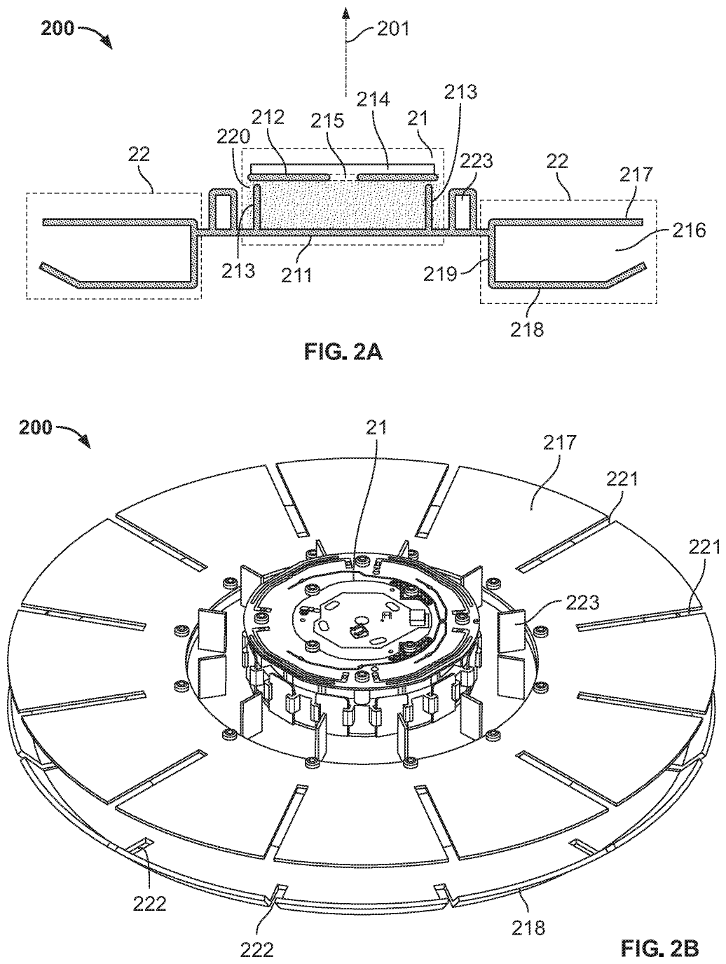

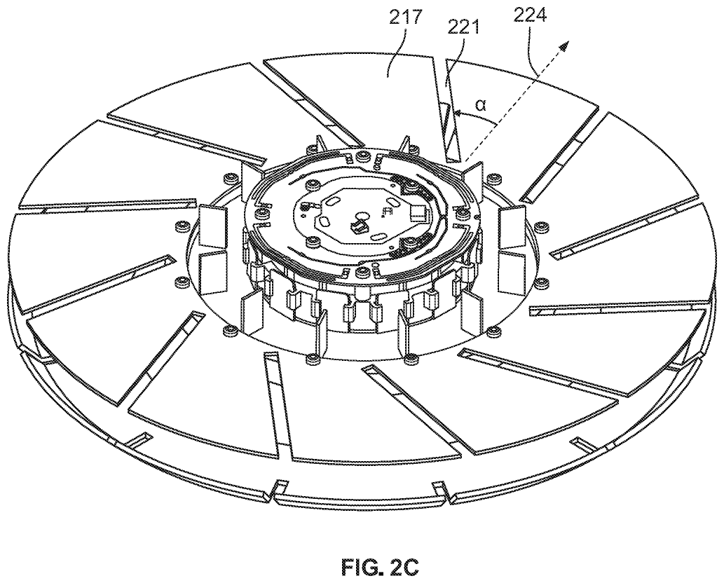

FIG. 2A shows a side view of antenna 200 according to one embodiment. FIG. 2B shows an isometric view of antenna 200. FIG. 2C shows an antenna which is a variant of the antenna shown in FIGS. 2A and 2B. Antenna 200 has 4-fold rotation symmetry about axis of symmetry 201 (i.e., each quarter of the antenna about axis of symmetry 201 is symmetrical). The direction of axis of symmetry 201 is coincident with the direction of the zenith. The direction along symmetry axis 201 will be referred to as the vertical direction, and the plane perpendicular to symmetry axis 201 will be referred to as the horizontal direction. Antenna 200 includes patch radiator 21 with top slot excitation and one-groove slotted vertical choke-ring structure 22.

Patch radiator 21 with top slot excitation includes: radiator ground plane 211, slot-fed radiating patch 212, feeding network 214, and elements in which vertical currents (i.e., conduction currents and/or polarization currents flowing in the vertical direction) flow which may include vertical pin conductors 213 and/or dielectric 220. A distinguishing feature of the patch radiator 21 with top slot excitation, as compared to a regular patch radiator, is that the patch radiator 21 with top slot excitation is able to suppress the signal coming from the lower hemisphere even when its ground plane is small.

Slot-fed radiating patch 212 is located above radiator ground plane 211. Slot-fed radiating patch 212 can be fixed using, for example, plastic spacers (not shown in FIG. 2A or 2B). Slot-fed radiating patch 212 is a conductive surface with a set of excitation slots 215. In one embodiment, inputs of feed network 214 are connected to excitation slots 215.

A structure in which vertical currents flow provides a required level of antenna gain and an axial ratio in the entire upper hemisphere, in particular, for elevation angles close to the horizon. For high-quality reception of signals from low-flying satellites, the antenna should have an antenna gain in the direction of the horizon not lower than −8 dBic (i.e., dB of an isotropic circular antenna). In one embodiment, the conductors and dielectric in which vertical currents flow are placed in a space between slot-fed radiating patch 212 and radiator ground plane 211. For example, FIG. 2A shows set of vertical pin conductors 213. connected to a radiator ground plane 211, as well as dielectric 220 which is shown as a dielectric cylinder according to one embodiment. In one embodiment, feeding network 214 is a power divider configured to ensure optimum reception of the RHCP wave.

In one embodiment, one-groove slotted vertical choke-ring structure 22 contains groove 216 of a certain depth formed by top conducting slotted surface 217 (also referred to as top conducting surface), bottom conducting surface 218, and vertical conducting cylinder 219 adjoining top conducting slotted surface 21 and bottom conducting surface 218. Vertical conducting cylinder 219 is connected to the outer perimeter of radiator ground plane 211. In one embodiment, radiator ground plane 211 and top conducting slotted surface 217 can be located in the same plane. In other embodiments, radiator ground plane 211 and top conducting slotted surface 217 can be located in different planes. Top conducting slotted surface 217 contains a set of extended (i.e., elongated) slots 221. Each of slots 221 has an end located on the outer perimeter of top conducting slotted surface 217. Slots 221 can be located both radially (as shown in FIG. 2B) and at an angle α relative to radial direction 224 (as shown in FIG. 2C). By changing angle α of slots 221, the level of antenna gain can be changed. If angle α is positive, then the antenna gain in the direction of the horizon decreases. If angle α is negative, then the antenna gain in the direction of the horizon increases. FIG. 2C shows an embodiment having a positive angle α. It should be noted that bottom conducting surface 218 may also contain a set of slots 222 as shown in FIG. 2B. These slots make it possible to reduce near field multipath.

To ensure maximum power transfer to antenna, high-quality matching is necessary. VSWR (voltage standing wave ratio) level is a measure used to evaluate how well the antenna is matched. Antenna matching is primarily provided by the design of the patch radiator 21. While changing the height of the vertical pin conductors 213 affects both the radiation pattern and the matching. To adjust the radiation pattern without affecting the matching in the embodiment shown in FIGS. 2A and 2B, a set of conductive ribs 223 are located on the surface of the radiator ground plane 211. Since conductive ribs 223 are located outside the perimeter of the slot-fed radiating patch 212 then set of ribs 223 only slightly affects the matching of patch radiator 21 (as compared to vertical pin conductors 213) but allows increase of the radiation pattern (RP) level in the direction perpendicular to axis 201. Also, changing the height of one of the ribs of set 223 allows to adjust the horizontal phase center of the antenna.

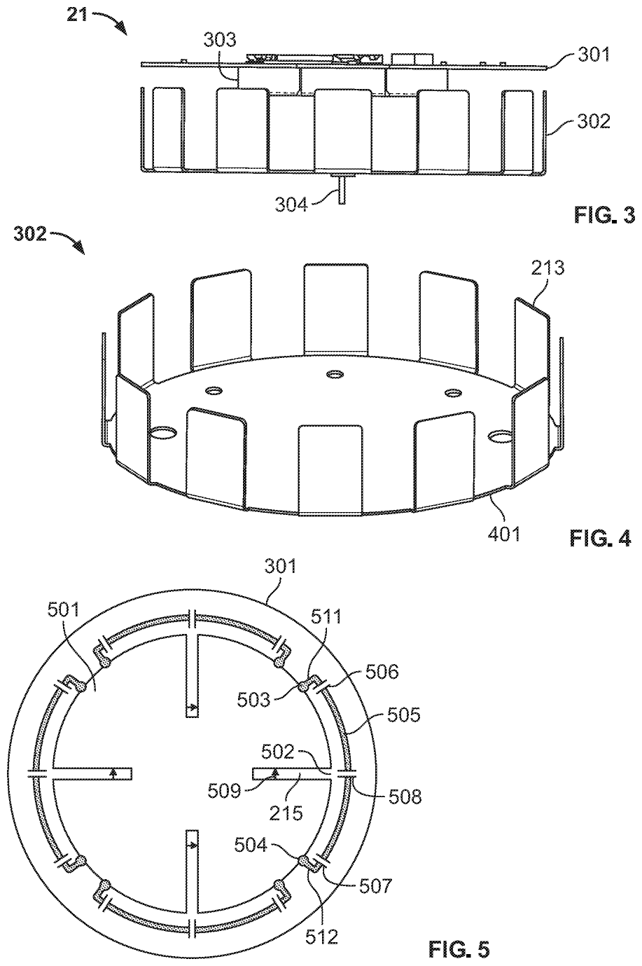

FIG. 3 shows an embodiment of patch radiator 21 with top slot excitation. In this embodiment, patch radiator 21 comprises a PCB 301 and a metal part 302. These parts are located one above the other using, for example, plastic spacers (not shown in FIG. 3). In this embodiment, slot-fed radiating patch 212 and feeding network 214 (shown in FIG. 2A) are made in the form of PCB 301 metallization layers. In this embodiment, a low noise amplifier (“LNA”) can be located on PCB 301, covered with shield 303. The LNA output is connected to output cable 304, which is located vertically in the center of the antenna.

FIG. 4 shows radiator ground plane 211 and vertical pin conductors 213 (shown in FIG. 2A as set of vertical pins 213) made in the form of metal part 302 according to one embodiment. In this embodiment, vertical pin conductors 213 are located along the perimeter of horizontal plane 401 and carry conduction currents and/or polarization currents. In this embodiment, horizontal plane 401 is part of the radiator ground plane 211 (shown in FIG. 2A). Metal part 302 can be made of any sheet material by stamping, followed by bending to form vertical pin conductors 213.

FIG. 5 shows slot-fed radiating patch 212 (shown in FIG. 2A) configured in the form of a metallization layer according to one embodiment. In this embodiment, the metallization layer is PCB 301 and the antenna design has 4-fold rotation symmetry. In this embodiment, slot-fed radiating patch 212 comprises conductive disk 501 having four substantially straight excitation slots 215. Each of the excitation slots 215 has an end 502 located on the outer perimeter of the disk 501. Connected to conductive disk 501 are four capacitive circuits 505 located outside the outer perimeter of conductive disk 501. In one embodiment, each of capacitive circuits 505 is located a same distance from the outer perimeter of conductive disk 501. Each of capacitive circuits 505 comprises a series of conductors and capacitors. Any of the capacitors can be made as a lumped element or a distributed element. In one embodiment, capacitive circuits 505 are configured in arcs terminating in radial segments 511 and 512. Each capacitive circuit 505 wraps around a respective excitation slot 215. Each capacitive circuit has a first end 503 and a second end 504 that are connected to a conductive disk 501. The points of the ends 503 and 504 are located along opposite sides of the corresponding excitation slot 215. Each capacitive circuit 505 includes at least three capacitors 506, 507, and 508 connected in series and located opposite a respective excitation slot 215. Capacitors 506 and 507 are connected to capacitive circuit 505 near points where capacitive circuit 505 is joined with disk 501. Capacitor 508 is located in capacitive circuit 505 opposite excitation slot 215.

Antenna 200 (shown in FIGS. 2A and 2B) has two resonances: a low-frequency (“LF”) and a high-frequency (“HF”). The resonant frequency of the LF band is determined by the size of radiating patch 212, the height of vertical pin conductors 213, and the capacitance value of capacitors 506 and 507 (shown in FIG. 5) Returning to FIG. 5, High-frequency resonance is implemented using capacitive circuits 505. The resonant frequency of the HF band is primarily determined by the capacitance of capacitor 508. Thus, a dual-band antenna operation is realized with good matching over the entire required frequency band, while the antenna design contains only one PCB 301.

Excitation slot 215 contain excitation probe 509, which is shown as an arrow in FIG. 5. Excitation probe 509 is connected to feeding network 214. Feeding network 214 is designed such that pairs of the excitation slots 215 opposite one another are excited in phase. In-phase excitation of opposite slots 215 is conditionally shown by the same direction of the arrows and pairs of the excitation slots 215 located at the angle of 90 degrees to each other are excited with a phase shift of 90 degrees. This ensures excitation of an RHCP wave. This excitation is achieved by the feeding network 214.

In one embodiment, excitation slots 215 can be shaped in a different form, for example, T-shaped. In one embodiment, the radius on which the set of vertical pin conductors 213 is located does not exceed the radius of the capacitive circuits 505.

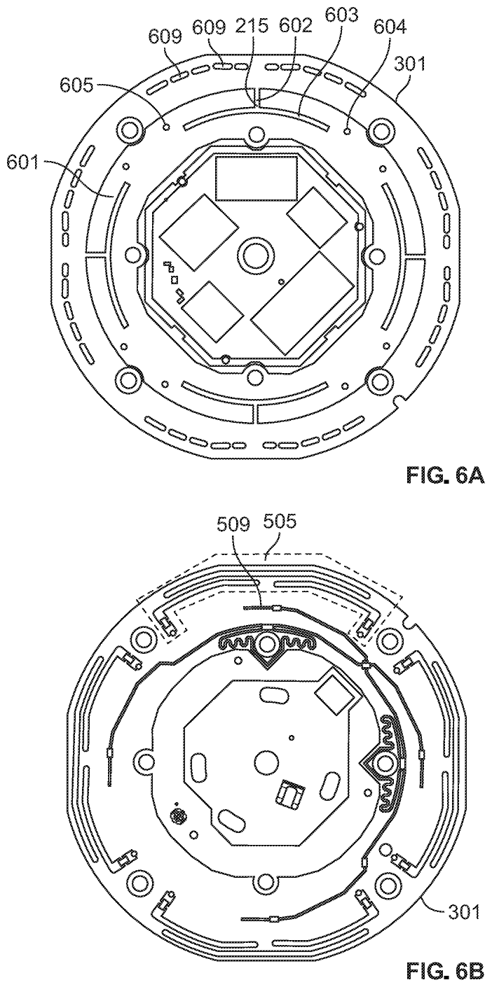

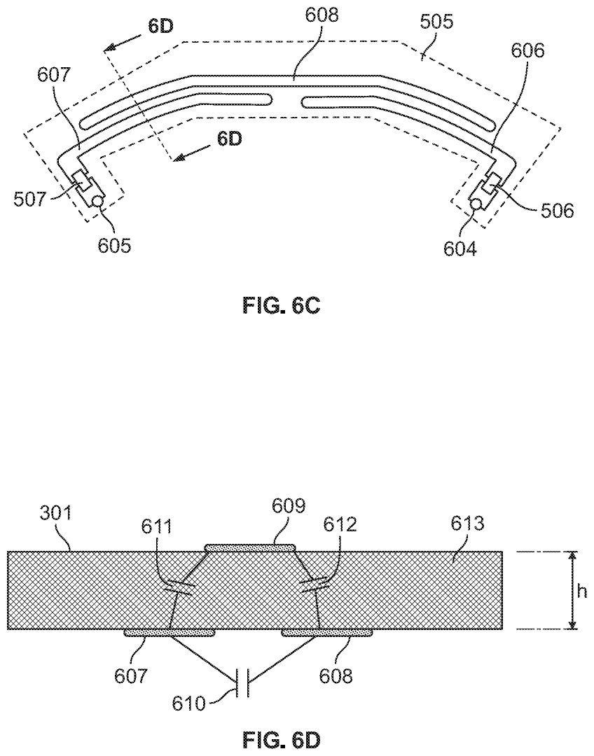

FIGS. 6A-6D show a variant of printed circuit board (“PCB”) 301 in which capacitors 508 are configured to be located in distributed elements. FIG. 6A shows a top metallization layer of PCB 301, and FIG. 6B shows a bottom metallization layer of PCB 301. In this embodiment, as described in conjunction with both FIGS. 6A and 6B, slot-fed radiating patch 212 (shown in FIG. 2A) is a conductive disk 601 located in the top metallization layer of PCB 301. Excitation slots 215 located in disk 601 are, in this embodiment, T-shaped. To accommodate this, each of slots 215 has a radial part 602 and an arcuate part 603. One end of radial part 602 of slot 215 is in contact with the perimeter of the conductive disk 601, and the other end is in contact with arcuate part 603.

Probes 509 are located in the lower metallization layer. Probes 509 are configured so that the electromagnetic field of an incident wave from a satellite, induced in excitation slots 215, enters feeding network 214 (shown in FIG. 2A). Probes 509 are continuations of microstrip lines that pass over excitation slots 215. The excitation technique of slots 215 using these kinds of probes 509 is widely known. Probes 509 are connected via microstrip lines to the feeding network 214 (shown in FIG. 2A). Feeding network 214, In one embodiment, is a set of power dividers designed in a manner to excite the RHCP wave. Feeding network 214 can be located on PCB 301.

Capacitive circuits 505 are formed on the lower metallization layer of PCB 301. FIG. 6C shows one of four capacitive circuits located on the lower metallization layer of PCB 301. Each capacitive circuit 505 includes capacitors 506 and 507 and conductors 606, 607, and 608. Capacitors 506 and 507 are implemented as lumped elements. Conductors 606, 607, and 608 are located outside the outer perimeter of disk 601 (shown in FIG. 6A). One end of capacitors 506 and 507 are connected to the conductive disk 601 through metallized holes 604 and 605. The other end of capacitors 506 and 507 are connected to conductors 606 and 607, respectively. Conductor 608 is located opposite conductors 606 and 607. There is a gap between conductors 608 and 606. Similarly, there is also a gap between conductors 608 and 607. Therefore, conductors 608 and 607 are capacitively coupled, and likewise, conductors 608 and 606 are capacitively coupled. Thus, equivalent capacitor 508 is implemented as a distributed circuit consisting of conductors 606, 607, and 608.

In one embodiment, a set of compensating conductors 609 is located in the upper metallization layer of PCB 301. These conductors are located in the gap between conductors 608 and 606, and in the gap between conductors 608 and 607.

FIG. 6D shows a section of PCB 301 in the area where conductors 607, 608, and 609 are located. Capacitor 610 is formed by conductors 607 and 608. Compensating capacitor 611 is formed by conductors 607 and 609. Compensating capacitor 612 is formed by conductors 608 and 609. An increase in height h of the dielectric substrate 613 increases the capacitance of capacitor 610, and the capacitance of capacitors 611 and 612 decreases. Therefore, the total capacitance of all three capacitors changes only slightly. In this configuration, the compensating conductors 609 reduce the influence of the variation in the thickness “h” value of the dielectric substrate 613 of the PCB 301 on the capacitance value formed by the conductors 606 and 608, as well as 607 and 608.

Changing the length of conductors 606 and 607 allows tuning of the antenna in the LF band, and the antenna can be tuned in the HF band by changing the length of conductor 608.

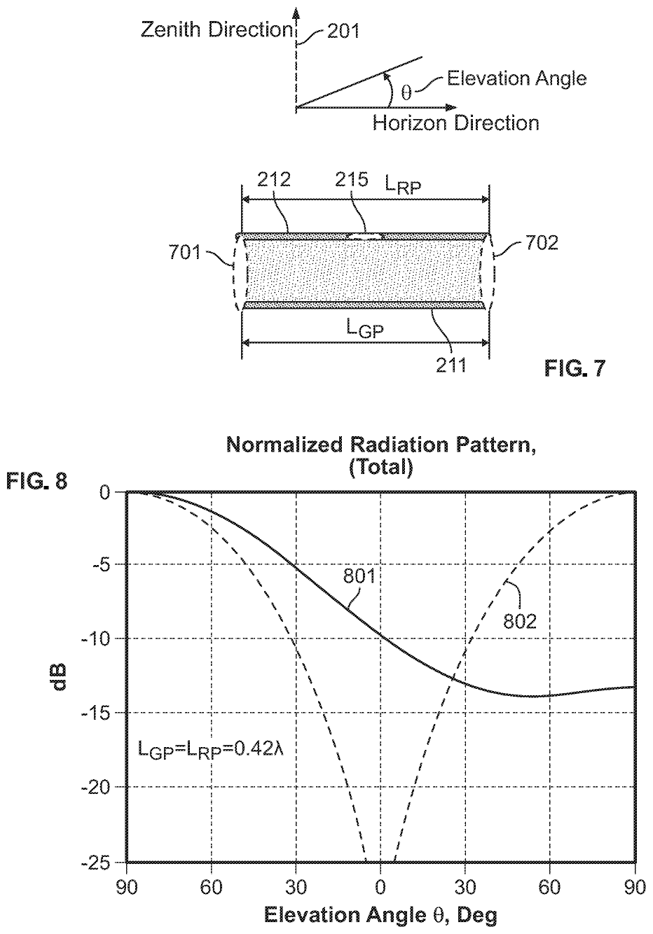

Patch radiator 21 with top slot excitation has an advantage over a conventional patch radiator. The advantage is that its use results in a simpler design of the vertical choke-ring structure. In order to demonstrate this advantage the properties of the patch radiator 21 itself (i.e. without the vertical choke-ring structure) are described here. FIG. 7 is a schematic showing the patch radiator 21 without vertical choke-ring structure for a limiting case where the size of slot-fed radiating patch 212 (as shown by length L_{RP}) is equal to that of the radiator ground plane 211 (as shown by length L_{GP}). This limiting case is indicative because in this case the ground plane 211 does not affect the level of the back lobe. As shown in FIG. 7, angle θ is the elevation angle from a particular direction to the horizon.

FIG. 8 shows a graph of calculated normalized radiation patterns based on elevation angle θ in configurations where the indicated lengths of the slot-fed radiating patch 212 and radiator ground plane 211 (as shown in FIG. 2A) are 0.42λ. In these configurations, λ is the signal wavelength in a vacuum. A dielectric with a relative dielectric constant of 4 was used in this configuration as dielectric substrate 220 in which vertical polarization currents flow. Curve 801 corresponds to the configuration of a patch radiator with top slot excitation. Curve 802 corresponds to the configuration of a conventional patch radiator. In one embodiment, when calculating curve 802, a probe feed was used. In the case of curve 802 for a conventional patch radiator, the back lobe level is equal to the main lobe level. And in the case of curve 801 for a patch radiator with top slot excitation, the back lobe level is 13 dB below the main lobe level. This is because in the case of a patch radiator with the top slot excitation, excitation slot 215 and side slots 701 and 702 radiate. Side slots 701 and 702 are the opposite legs of a cylindrical peripheral slot formed by edges of slot-fed radiating patch 212 and radiator ground plane 211. Fields formed by side slots 701, 702 and excitation slot 215 in the direction θ=90 degrees are added, and in the direction θ=−90 degrees are subtracted. FIG. 8 shows that the front-to-back ratio is about 13 dB. In the case of a conventional patch radiator, only side slots are radiative. In the case where L_{RP}=L_{GP}, side slots in the directions θ=90 degrees and θ=−90 degrees radiate in the same manner, i.e., the front-to-back ratio is 0 dB.

Patch radiator 21 with top slot excitation has the absence of deep beam dips in the horizon direction when the size of radiating patch 212 is approximately 0.5λ. A radiation pattern of a conventional patch antenna normally has a deep dip in the horizon direction. This is due to L_{RP}=0.5λ (i.e., the distance between side slots 701 and 702 being 0.5λ). In the case of a conventional patch antenna without excitation slot 215, electromagnetic fields formed by side slots 701 and 702 in the horizon direction are opposite phase and cancel each other. Patch radiator 21 with top slot excitation also has radiation formed by excitation slot 215. Its field is not subtracted, so in this scenario there is no deep dip in the horizon direction.

As shown in FIG. 8, at θ=0 degrees, curve 802 has a deep dip, with the level of the curve 801 being about −10 dB. This level is acceptable for receiving a signal from satellites located near the horizon. Therefore, patch radiator 21 with top slot excitation can have a diameter of up to 0.5λ, which makes it possible to expand its operating frequency band, as well as place feeding network 214, LNA, and a set of filters on the slot-fed radiating patch 212, which can occupy a substantially large area. The diameter of the radiating patch of a conventional patch antenna typically does not exceed 0.3λ.

As described above, patch radiator 21 with top slot excitation itself has the ability to suppress multipath signals. Therefore, to achieve the required the front-to-back ratio of about 20 dB and higher, it is sufficient to install it on a vertical choke-ring structure 22 with just one groove 216.

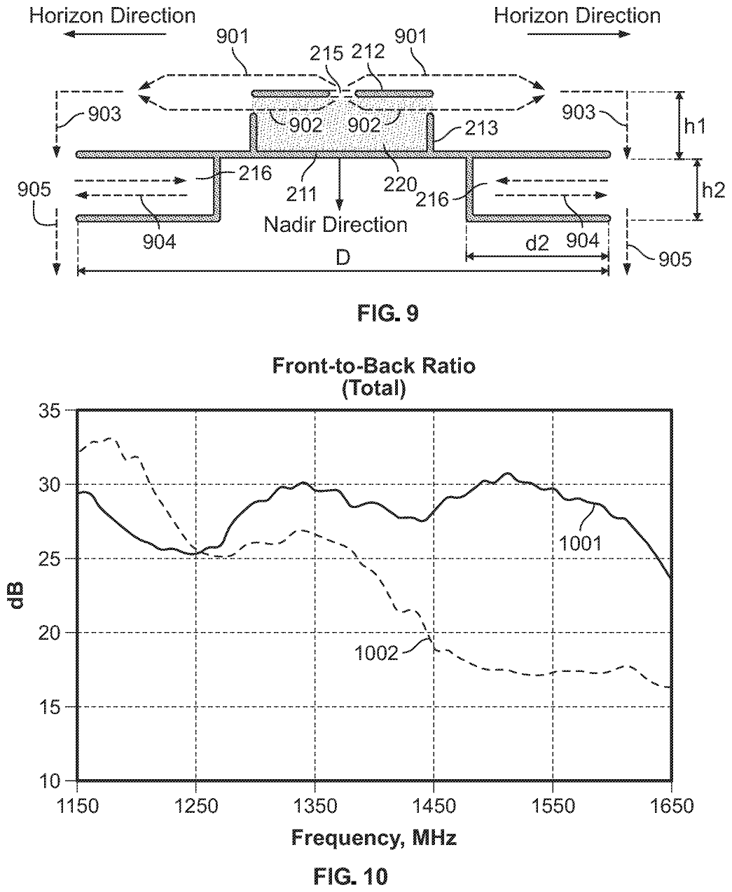

FIG. 9 shows a signal propagation diagram that illustrates the operation of antenna 200 according to one embodiment. Although the GNSS antenna is a receiving antenna configured to operate in a receiving mode, the transmitting mode is shown in FIG. 9 for convenience. It should be noted that the reciprocity theorem indicates that the parameters pertaining to both the transmitting mode of operation and the receiving mode of operation are equal. Excitation slot 215 radiates an electromagnetic field that propagates toward the horizon in two paths 901 and 902. Path 901 passes over slot-fed radiating patch 212 and path 902 passes between slot-fed radiating patch 212 and radiator ground plane 211. The presence of vertical pin conductors 213 or dielectric substrate 220 results in changing the phase of the wave along path 902. The parameters of vertical pin conductors 213 or dielectric substrate 220 can be chosen such that the waves traveling paths 901 and 902 are opposite phase and cancel each other. As a result, a weakened wave 903 approaches groove 216 of the vertical choke-ring structure. Passing along groove 216, wave 903 is further attenuated due to interference with wave 904 reflected from groove 216. As a result, wave 905, which propagates into the back hemisphere, is significantly weakened.

FIG. 10 shows a graph pertaining to experimental plots of front-to-back ratio showing decibels (dB) versus frequency. The antenna design used to generate the plots shown in FIG. 10 has the following dimensions (see dimensional labels shown in FIG. 9): D=250 mm, h2=22 mm, h1=22 mm, d2=47 mm. Curve 1001 corresponds to an antenna design according to an embodiment in which patch radiator 21 with the top slot excitation is installed on one-groove slotted vertical choke-ring structure 22. As shown in FIG. 10, in this scenario the value of the Front-to-Back ratio in the entire operating frequency band of GNSS range is not lower than 25 dB. Curve 1002 is measured with a regular stacked patch antenna installed on the same one-groove slotted vertical choke-ring structure 22. As shown in FIG. 10, in this scenario the value of the front-to-back ratio in the high-frequency GNSS range is significantly lower and is approximately 17 dB.

The presence of slots 221 located on top conducting slotted surface 217 (shown in FIGS. 2A and 2B) results in a decrease in near-field multipath signal strength. The magnitude of the undesirable near field in the rear hemisphere can be estimated from the magnitude of the electric field on the axis of symmetry of the antenna.

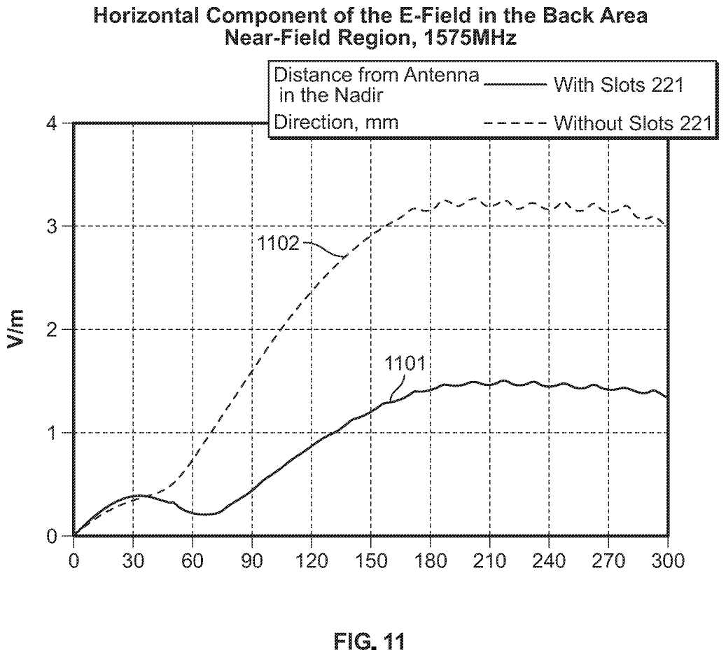

FIG. 11 shows a graph pertaining to a horizontal component of an E-field in a back area near-field region showing voltage per meter versus distance from an antenna in the nadir direction in millimeters. The distance was counted from the radiator ground plane in the direction opposite to axis 201 (shown in FIG. 2A), i.e., in the nadir direction. Curve 1101 corresponds to the case when slots 221 (shown in FIG. 2B) were present and curve 1102 corresponds to the case when slots 221 were absent. As shown in FIG. 11, the availability of slots 221 located on top conducting slotted surface 217 leads to a reduction in the undesirable near field by approximately a factor of 2.

As described above, varying the angle of rotation a of the slots 221 located on top conducting slotted surface 217 allows the antenna gain for zenith and horizon direction to be changed. The direction of the angle α is shown in FIG. 2C.

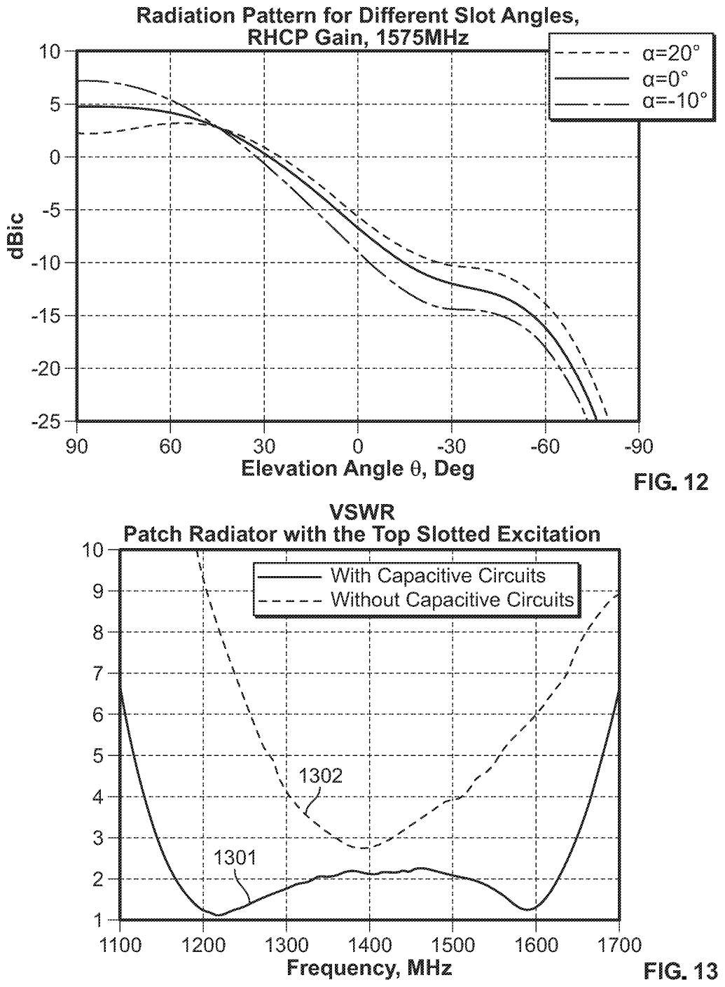

FIG. 12 shows a graph of experimental plots of radiation patterns for different slot angles α showing dBic (i.e., dB of an isotropic circular antenna) versus elevation angles θ in degrees. It can be seen that by changing the angle α from −10° to +20°, it is possible to change the antenna gain towards the horizon (θ=0 degrees) by 3 dB.

FIG. 13 shows a graph of voltage standing wave ratio (“VSWR”) dependence on frequency showing VSWR versus frequency in MHz. Curve 1301 shows the case when capacitive circuits 505 (shown in FIGS. 5, 6B, and 6C) are connected to the radiation patch, curve 1302 shows the case when there are no capacitive circuits 505. In one embodiment, the diameter of PCB 301 with slot-fed radiating patch 212 and capacitive circuits 505 is 80 mm and the distance between radiating patch PCB 301 and the radiator ground plane is 22 mm. It can be seen that the antenna according to one embodiment, in the presence of capacitive circuits 505, provides a VSWR level of less than two in the entire GNSS range.

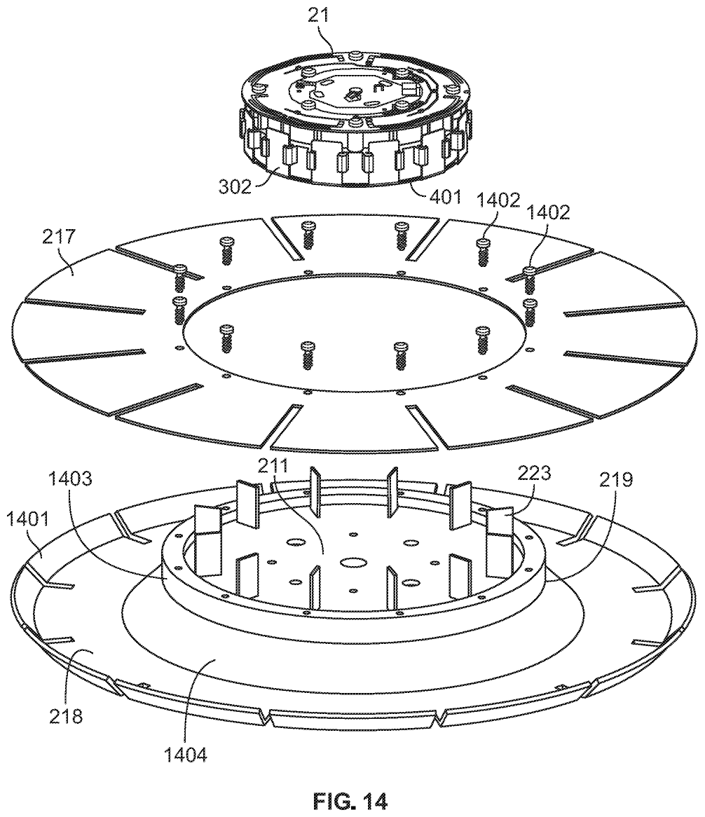

FIG. 14 shows an embodiment of an antenna formed using three main components. As shown in FIG. 14, bottom conducting surface 218, vertical conducting cylinder 219, the radiator ground plane 211, and the set of conducting ribs 223 are formed as a one-piece component 1401, which may be made of metallized plastic. Top conducting slotted surface 217 is screwed to component 1401 with screws 1402. Top conducting slotted surface 217, in one embodiment, can be made of sheet material by, for example, laser cutting. Thus, in one embodiment, one-groove slotted vertical choke-ring structure 22 contains only two parts. Patch radiator 21 with top slot excitation is installed on the radiator ground plane 211. In this embodiment, horizontal surface 401 of the part 302 is in contact with radiator ground plane 211. Vertical conducting cylinder 219 can have a vertical part 1403 and a conical part 1404.

The foregoing Detailed Description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. An antenna having a vertical axis, the antenna comprising:
a patch radiator comprising:
a printed circuit board (“PCB”) comprising:
a feeding network configured for reception or transmission of a right hand circularly polarized (“RHCP”) wave; and
a slot-fed radiating patch perpendicular to the vertical axis comprising:
a set of four excitation slots connected to the feeding network through microstrip lines;
a ground plane;
a dielectric located between the ground plane and the slot-fed radiating patch;
a plurality of vertical conductors located between the ground plane and the slot fed radiating patch, the dielectric and plurality of vertical conductors configured to carry one or both of conduction currents and polarization currents in the direction of the vertical axis; and
a vertical choke-ring structure comprising:
a top conducting surface comprising a set of extended slots, each slot comprising an end located on the outer perimeter of the top conducting surface;
a bottom conducting surface; and
a conducting cylinder comprising a top edge and a bottom edge, the top edge connected to the top conducting surface and the bottom edge connected to the bottom conducting surface, the ground plane connected to the conducting cylinder along the outer edge of the ground plane.

2. The antenna of claim 1, further comprising:
four capacitive circuits located on the PCB beyond the outer perimeter of the slot-fed radiating patch, each of the four capacitive circuits comprising:
a first end; and
a second end; and
at least three capacitors connected together in series,
wherein the first end of each of the four capacitive circuits is connected to a respective first point located on the perimeter of the slot-fed radiating patch, the second end of each capacitive circuit connected to a respective second point located on the perimeter of the slot-fed radiating patch, the respective first point and the respective second point located on opposite sides of a corresponding one of the set of four excitation slots, a first of the at least three capacitors located near the first point, a second of the at least three capacitors located near the second point, and a third of the at least three capacitors located opposite a corresponding excitation slot.

3. The antenna of claim 2, wherein the at least three capacitors are formed using lumped elements.

4. The antenna of claim 2, wherein a third capacitor of the at least three capacitors is formed as a distributed element comprising:
three conductors located on a first side of the PCB; and
a set of compensating conductors located on a second side of the PCB,
wherein, a first conductor of the three conductors comprises a first end connected to a first capacitive element and a second end that is insulated,
a second conductor of the three conductors comprises a first end connected to the second capacitive element and a second end that is insulated,
a third conductor located opposite the excitation slot, both ends of the third conductor are insulated,
the set of compensating conductors located between the third conductor and the first conductor, and between the third conductor and the second conductor, and
the first end of the third conductor having an overlap with the second end of the first conductor, the second end of the third conductor having an overlap with the second end of the second conductor.

5. The antenna of claim 1, wherein the dielectric comprises a dielectric cylinder having a top surface and a bottom surface, the top surface adjacent to the PCB, the bottom surface adjacent to the ground plane.

6. The antenna of claim 1, wherein each of the plurality of conductors located between the ground plane and the slot-fed radiating patch comprises a pin connected to the ground plane and located inside the outer perimeter of the PCB.

7. The antenna of claim 1, wherein each of the excitation slots is substantially straight and has an end located at an outer perimeter of the slot-fed radiating patch.

8. The antenna of claim 1, wherein each of the excitation slots is T-shaped and has an end located at an outer perimeter of the slot-fed radiating patch.

9. The antenna of claim 1, further comprising:
a set of conductive ribs connected to the ground plane and located outside the outer perimeter of the PCB.

10. The antenna of claim 1, wherein each slot of the set of extended slots on the top conducting surface is rotated at an angle.

11. The antenna of claim 1, wherein the bottom conducting surface comprises a set of extended slots each of which having an end located on the outer perimeter of the bottom conducting surface.

12. The antenna of claim 9, wherein the bottom conducting surface, the conducting cylinder, the ground plane, and the set of conductive ribs are formed as one piece.

13. An antenna having a vertical axis, the antenna comprising:
a one-groove slotted vertical choke-ring structure comprising:
a top conducting slotted surface;
a one-piece component attached to the top conducting slotted surface, the one-piece component comprising:
a bottom conducting surface;
a vertical conducting cylinder connected to the bottom conducting surface;
a radiator ground plane connected to the vertical conducting cylinder; and
a set of conducting ribs connected to the radiator ground plane; and
a patch radiator connected to the one-piece component.

14. The antenna of claim 13, the patch radiator comprising:
a printed circuit board (“PCB”) comprising:
a feeding network; and
a slot-fed radiating patch perpendicular to the vertical axis comprising:
a set of four excitation slots connected to the feeding network through microstrip lines, each of the excitation slots having an end located at an outer perimeter of the slot-fed radiating patch.

15. The antenna of claim 14, the top conducting slotted surface comprising:
a set of extended slots, each slot comprising an end located on the outer perimeter of the top conducting slotted surface.

16. The antenna of claim 14, wherein the antenna has 4-fold symmetry about the vertical axis and has a front-to-back ratio level of at least 20 dB in an operating frequency band.

17. The antenna of claim 14, wherein each of the set of four excitation slots is substantially straight.

18. The antenna of claim 14, wherein each of the set of four excitation slots is T-shaped.

19. The antenna of claim 15, wherein each slot of the set of extended slots on the top conducting surface is rotated at an angle.

20. The antenna of claim 14, wherein the bottom conducting surface comprises a set of extended slots each of which having an end located on the outer perimeter of the bottom conducting surface.
